(19) United States
(12) Patent Application Publication
(10) Pub. No.: US 2025/0040528 A1
(43) Pub. Date: Feb. 6, 2025

(54) FISHING REEL

(71) Applicant: Shimano Inc., Osaka (JP)

(72) Inventor: Kohei NAKAMURA, Osaka (JP)

(21) Appl. No.: 18/643,519

(22) Filed: Apr. 23, 2024

(30) Foreign Application Priority Data
Jul. 31, 2023 (JP) 2023-124069

(51) Int. Cl. A01K 89/015; A01K 97/00

(52) U.S. Cl. CPC A01K 89/0187; A01K 89/01912; A01K 97/00

(57) ABSTRACT

A fishing reel includes a spool, a spool shaft supported by a reel body so as to be freely rotatable and to rotate integrally with the spool, a clutch mechanism to switch between a transmitting state in which winding power is transmitted to the spool and a dis-transmitting state in which transmission of the winding power to the spool is cut off, a clutch operating unit to operate the clutch mechanism, a shift mechanism in a first mode while the clutch mechanism is in the transmitting state, and which shifts to a second mode that is different from the first mode while the clutch mechanism is in the dis-transmitting state, and a detection unit to detect at least one of the first mode or the second mode of the shift mechanism.

### CROSS-REFERENCE TO RELATED APPLICATIONS

This application claims priority to Japanese Patent Application No. 2023-124069, filed on Jul. 31, 2023. The entire disclosure of Japanese Patent Application No. 2023-124069 are hereby incorporated by reference.

### BACKGROUND

### Technical Field

The present disclosure relates to a fishing reel.

### Background Information

Conventional fishing reels including a detection sensor, such as a magnetic sensor, near the rear side of a clutch actuating plate, thereby detecting ON/OFF of a clutch, are known (for example, refer to Japanese Patent No. 7057274).

### SUMMARY

In a fishing reel such as the one disclosed in Japanese Patent No. 7057274, a detection target, such as a magnet, is provided on a clutch actuating plate. In this fishing reel, the clutch actuating plate constitutes a clutch lever, and a detection sensor, such as a magnetic sensor, is embedded in a portion of reel body that the clutch actuating plate faces. Therefore, the clutch lever is large, and the shape of a rear-end portion of the reel body that houses the detection sensor together with the clutch lever is large. It has been determined that this configuration reduces palming performance of the fishing reel 100 during use, and therefore there is room for improvement in this regard. In addition, it has been determined that because a sensor is provided at the rear-end portion of the fishing reel, the weight of the rear-end portion increases and the balance between the front and rear is poor, thereby reducing the casting performance. Thus, there is room for improvement in this regard.

The present disclosure was conceived in light of these circumstances, and an object thereof is to provide a fishing reel that can improve the palming performance of the fishing reel 100 during use, and to provide a fishing reel that achieves balance between the front and rear of the fishing reel, thereby improving casting performance.

A first aspect of a fishing reel according to the present disclosure is a fishing reel comprising a spool, a clutch, a clutch operating unit, a shift mechanism, and a detection unit. The spool is capable of releasing a fishing line in a first direction. The spool is supported by a reel body so as to be freely rotatable. The clutch mechanism is capable of switching between a transmitting state in which winding power is transmitted to the spool and a dis-transmitting state in which transmission of the winding power to the spool is cut off. The clutch operating unit operates the clutch mechanism a second direction that is opposite of the first direction with respect to the spool shaft. The shift mechanism is configured to be in a first mode when the clutch mechanism is in the transmitting state, and is capable of shifting to a second mode that is different from the first mode when the clutch mechanism is in the dis-transmitting state. The detection unit is provided in the first direction with respect to the spool shaft and detects the mode of the shift mechanism.

By the first aspect of the fishing reel according to the present disclosure, the detection unit can detect changes in the position of a shift mechanism, such as a link mechanism or a fishing line guiding mechanism that moves by a clutch operation. The shift mechanism can be located on a side that is in a first direction of the fishing line release (casting) direction of the spool shaft, the side in the first direction being different from a side of which the clutch operating unit is provided. That is, the clutch operating unit is provided on a side that is in the second direction of the fishing line release (casting) direction of the spool shaft, and is therefore opposite the shift mechanism. Accordingly, it is possible to detect, with a position detection device, the ON/OFF position of a clutch based on the mode (i.e., first mode and the second mode) of the shift mechanism that shifts by an operation of the clutch operating unit. In this manner, with the present disclosure, a space near the end in the second direction for embedding a detection unit near the rear end of the reel body is unnecessary. As a result, the area of the clutch operating unit at the rear end of the reel body does not protrude rearward in the second direction, which improves the palming performance. Furthermore, in the present disclosure, since the detection unit is not embedded near the rear end of the reel body, the weight near the rear end is reduced and the front-rear balance is maintained, which improves casting performance. In some embodiments, it has been determined that the front-rear balance can be slightly front-loaded, which further improves casting performance.

A second aspect of the present disclosure is the fishing reel according to the first aspect, wherein, the shift mechanism includes a line guide that assumes a winding position for guiding the fishing line to the spool when in the first mode, and that assumes a releasing position for releasing the fishing line from the spool when in the second mode, and the detection unit detects the position of the line guide, as the detection of the mode of the shift mechanism.

By the second aspect, as a result of the shift mechanism being equipped with the line guide that can switch between the winding position and the releasing position, moving in accordance with the state of the clutch mechanism, the position of the line guide can be detected with the detection unit. In this case, since the position of the line guide is relatively large, the detection of the ON/OFF positions of the clutch can be more reliably and accurately detected. In addition, since the clutch operating unit and the line guide are located basically on opposite sides across the spool shaft in the front-rear direction, the rear end of the reel body does not protrude rearward in the second direction, thereby improving the palming performance.

A third aspect of the present disclosure is the fishing reel according to the second aspect, wherein, the line guide includes a worm shaft, a cylindrical body, a slider, and a guide. The worm shaft has a spiral groove on an outer periphery thereof. The cylindrical body is provided on the outer periphery of the worm shaft, is opened along an axial direction of the worm shaft, and has a long hole that exposes a part of the spiral groove. The slider engages the spiral groove via the long hole and slides along the long hole as the worm shaft rotates. The guide part guides the fishing line, and includes a narrow (first) guide portion that slides together with the slider and has a narrow width in the axial direction of the spool shaft and a wide (second) guide portion that has a wide width in the axial direction of the spool shaft. The guide part is positioned at a swing position on the second direction side about the worm shaft so as to guide the fishing line to the narrow guide portion when in the winding position, is positioned at a swing position on the first direction side about the worm shaft so as to guide the fishing line to the wide guide portion when in the releasing position. The detection unit detects the swing position of the guide part as the detection of the position of the line guide.

By the third aspect, as a result of the shift mechanism having a line guide that includes a worm shaft, a cylindrical body, a slider, and a guide part, in which the guide part has a narrow guide portion and a wide guide portion that can switch between the winding position and the releasing position, moving in accordance with the state of the clutch mechanism, the position of the line guide can be detected with the detection unit. In this case, since the position of the guide part of the line guide is relatively large, the detection of the ON/OFF positions of the clutch can be more reliably and accurately detected. In addition, since the clutch operating unit and the line guide are located nearly on opposite sides across the spool shaft in the front-rear direction, the rear end of the reel body does not protrude rearward in the second direction, thereby improving the palming performance.

A fourth aspect of the present disclosure is the fishing reel according to the third aspect, wherein the detection unit can detect a rotational position of a cylindrical body that rotates around the worm shaft in accordance with the swing position of the guide part, as the detection of the swing position of the guide part.

By the fourth aspect, it is possible to detect, with the detection unit, the rotational position of a cylindrical body that is rotationally driven by an operation of the clutch operating unit, such as one composed of a drive shaft of a level winding device.

A fifth aspect of the present disclosure is the fishing reel according to any one of the first through fourth aspects, wherein the detection unit can be a magnetic sensor that detects the mode of the shift mechanism by magnetism.

By the fifth aspect, it is possible to detect the position of the shift mechanism by a detection unit with a simple structure, composed of a magnet and a magnetic sensor. Since it is not a complex structure, a small magnet and a magnetic sensor can be disposed using the small space in front of the spool shaft on the first direction side so that the space inside the reel body can be effectively used.

By using the fishing reel according to the present disclosure, it is possible to reduce the rearward protrusion of the rear end of the reel body, thereby improving the palming performance of the fishing reel 100 during use.

In addition, by using the fishing reel according to the present disclosure, it is possible to achieve balance between the front and rear of the fishing reel, thereby improving the casting performance.

### BRIEF DESCRIPTION OF THE DRAWINGS

FIG. 1 is a plan view showing a fishing reel according to an embodiment of the present disclosure, in which a line guide portion is exposed.

FIG. 2 is a side view clutch ON state showing a configuration of a power transmission portion of a clutch mechanism in the clutch ON state in the fishing reel shown in FIG. 1.

FIG. 3 is a side view showing a configuration of the power transmission portion of the clutch mechanism in the clutch OFF state in the fishing reel shown in FIG. 1.

FIG. 4 is a cross-sectional view showing a structure of a connecting portion between a clutch plate and a rotating plate that rotates the line guide.

FIG. 5 is a longitudinal cross-sectional view of the fishing reel shown in FIG. 1, showing when the line guide is in the line winding state (i.e., clutch ON state).

FIG. 6 is a longitudinal cross-sectional view of the fishing reel shown in FIG. 1, showing when the line guide is in the line releasing state (i.e., clutch OFF state).

FIG. 7 is an enlarged perspective view of the line guide in the clutch ON state.

FIG. 8 is a front view of the line guide shown in FIG. 7.

### DETAILED DESCRIPTION OF EMBODIMENTS

An embodiment of the fishing reel according to the present disclosure will be described below with reference to the drawings. In each of the drawings, there are cases in which the scale of each component has been appropriately changed as required to improve the visibility of the component.

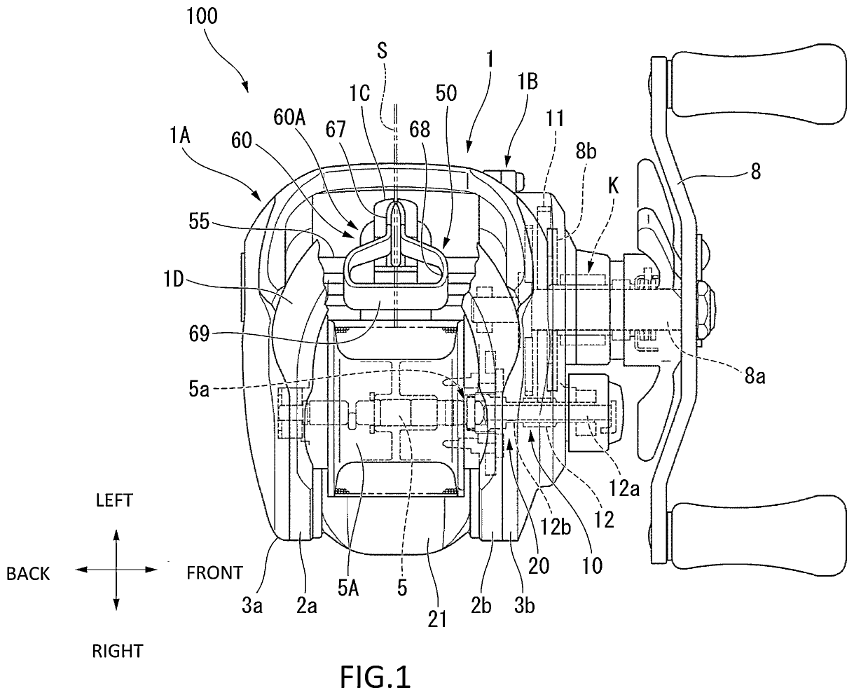

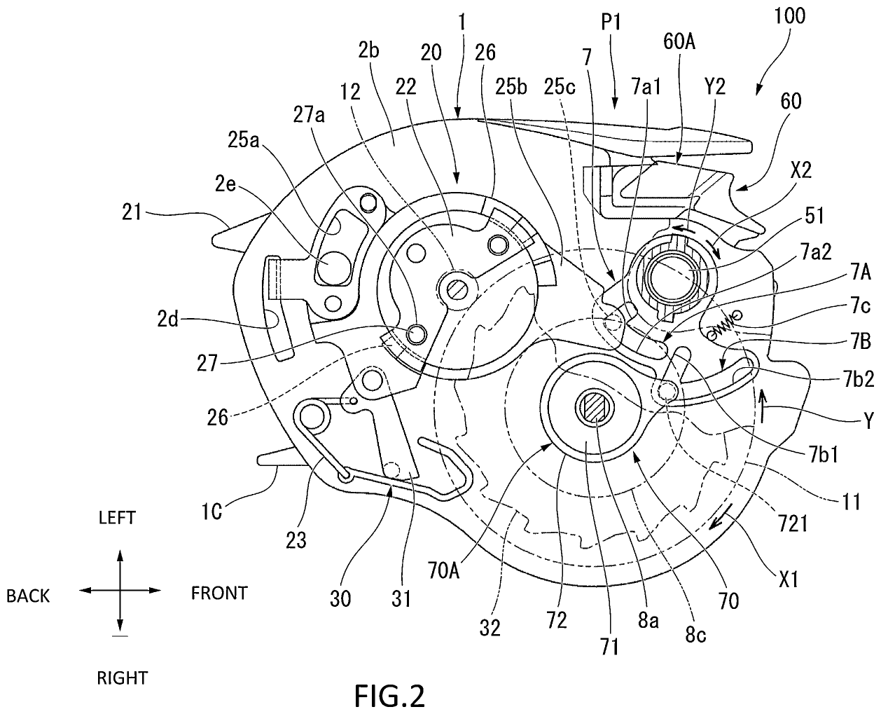

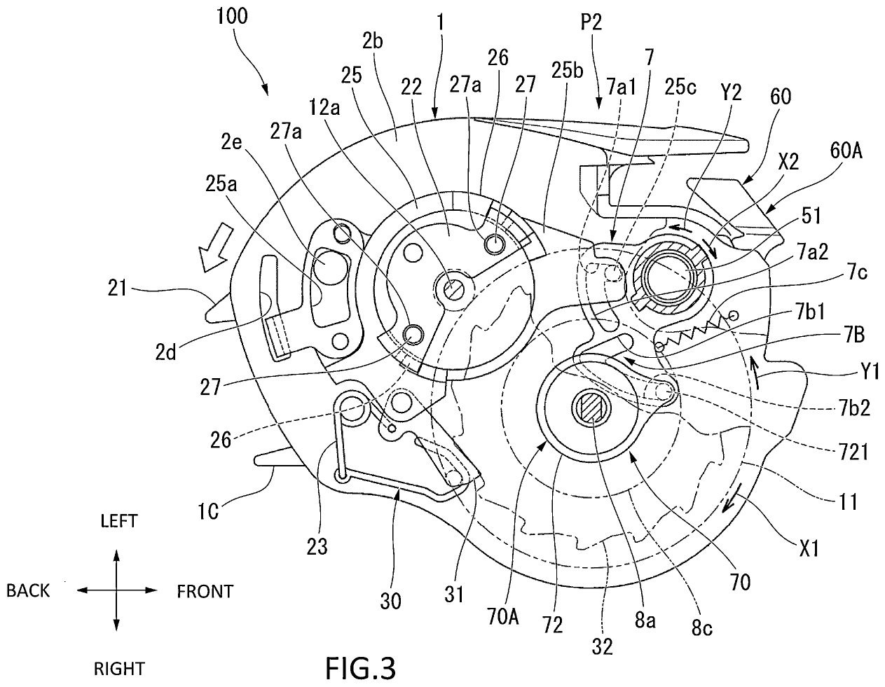

As shown in FIG. 1, a fishing reel 100 of the present embodiment is applied to a dual-bearing reel. In the following description, “front/rear” and “left/right” refer to the directions shown in FIG. 1, and “up/down” refer to the directions shown in FIGS. 2 and 3. “Forward” is the first direction of the present disclosure, and “rearward” is the second direction of the present disclosure. The same elements are given the same reference numerals in the explanation, and redundant explanations will be omitted.

As shown in FIG. 1, the fishing reel 1 has a reel body 1 with left and right side plates 1A, 1B. The left and right side plates 1A, 1B are configured such that left and right frames 2a, 2b are covered by left and right covers 3a, 3b. A reel foot IC can be mounted on a fishing rod (not shown) and that is positioned between the left and right side plates 1A, 1B is integrally formed with the reel body 1. A spool shaft 5 is rotatably supported between the left and right frames 2a, 2b via shaft bearings, and a spool 5A, around which a fishing line S is wound, is integrally fixed to the spool shaft 5. In addition, a thumb rest 1D, on which a finger can be placed, is disposed between the left and right side plates 1A, 1B above the spool 5A.

A handle 8 for rotationally driving the spool 5A is installed on the right side plate 1B side. A space is formed between the right frame 2b and the right cover 3b, and a drive force transmission mechanism 10 that transmits the rotational drive force of the handle 8 to the spool shaft 5 is disposed in the space formed between the right frame 2b and the right cover 3b. In addition, FIG. 2 illustrates a clutch mechanism 20 that switches the spool shaft 5 between a power transmitting state and a power dis-transmitting state disposed between the right frame 2b and the right cover 3b. The clutch mechanism 20 is configured to switch from a clutch ON state P1 (i.e., a power transmitting state, line winding state, first mode) to a clutch OFF state P2 (i.e., a power off state, line releasing state, second mode), by a pressing operation of a clutch switching operating member (hereinafter referred to as clutch operating unit), which is disposed between the left and right side plates 1A, 1B behind the spool 5A. As shown in FIG. 2, returning from the clutch OFF state P2 to the clutch ON state P1 can be carried out by an automatic return mechanism 30 while rotating the handle 8, described further below.

Furthermore, as shown in FIGS. 2 and 3, a switching mechanism 70 is disposed between the right frame 2b and the right cover 3b. When in the line winding state, the switching mechanism 70 drives a line guide 60 to change its position. Details of the switching mechanism 70 will be described further below.

As shown in FIG. 1, a level winding device 50 is disposed between the left and right side plates 1A, 1B in the line delivering direction (casting) of the spool 5A. The level winding device 50 includes the line guide 60 (i.e., the shift mechanism) through which the fishing line S is inserted. The line guide 60 is configured to move left and right in a reciprocating fashion due to the rotation of the handle 8, and enables evenly distributed winding the fishing line S around the spool 5A.

The drive force transmission mechanism 10 comprises a drive gear 11 configured to rotate and frictionally coupled to a handle shaft 8a to which the handle 8 is fixed. The drive gear 11 is rotatably supported on the right side plate 1B by the drag device 8b, and a pinion 12 meshes with the drive gear 11. When the handle 8 is rotated at the time of winding the fishing line, the drive gear 11 rotates in the X1 direction (i.e., clockwise), as shown in FIG. 2. In addition, the drive gear 11 is configured to rotate in the Y direction (i.e., counterclockwise)), as shown in FIG. 2 via the spool 5A, the spool shaft 5, and the pinion 12, when the fishing line S is cast out against the drag force imparted by the drag device 8b.

As can be understood, the handle shaft 8a can rotate in the line-winding direction but is prevented from rotating in the reverse direction while the fishing line is being cast by a one-way clutch K. The one-way clutch K can be a roller-type one-way clutch that utilizes a wedge action, as shown in FIG. 1, and is provided between the handle shaft 8a and the right cover 3b. The handle shaft 8a is rotatably supported via a shaft bearing (not shown) provided on the right frame 2b.

As shown in FIG. 1, the pinion 12 is disposed coaxially relative to the spool shaft 5 and is configured to be movable in the axial direction along a pinion shaft 12a (or the spool shaft 5). In addition, the pinion 12 includes a circumferential groove 12b formed on the outer periphery thereof and is configured such that a yoke 22, see FIG. 2, of the clutch mechanism 20, described below, engages the circumferential groove 12b to move the pinion 12 in the axial direction. That is, it is configured such that the pinion 12 moves in the axial direction to be coupled with/decoupled from the spool shaft 5, thereby switching between the power transmitting state (clutch ON) and the power dis-transmitting state (clutch OFF).

As shown in FIGS. 2 and 3, the clutch mechanism 20 includes a clutch plate 25 that is supported so as to be rotatable with respect to the right frame 2b. The clutch plate 25 is toggled and held between the power transmitting state (clutch ON state) shown in FIG. 2 and the power dis-transmitting state (clutch OFF state) shown in FIG. 3 by a toggle spring 23. The clutch plate 25 is connected to a clutch operating unit 21 via a connecting hole 2d formed on the right frame 2b in the up-down direction, and is configured such that a pin 2e, protruding from the right frame 2b, is inserted in a long hole 25a formed on the clutch plate 25, thereby guiding the rotating thereof.

A pair of cam surfaces 26 are formed on the surface of the clutch plate 25. The pair of cam surfaces 26 can engage with the yoke 22, which is engaged with the circumferential groove 12b (see FIG. 1) of the pinion 12. The distal end side of the yoke 22 is held by a pair of support pins 27 protruding from the right frame 2b, and the yoke 22 is constantly biased toward the spool shaft 5 side by spring members 27a provided on the support pins 27. FIG. 2 shows a state in which the yoke 22 is biased toward the spool shaft 5 side by the spring members; at this time, the pinion 12 is engaged with an engagement portion 5a (see FIG. 1) formed at the end of the spool shaft 5, and the clutch is in the clutch ON state P1.

When the clutch operating unit 21 is pressed down, as shown by the hollow arrow of FIG. 3, the clutch plate 25 rotates in the counterclockwise direction. With this rotating, as shown in FIG. 1, the clutch plate 25 moves the pinion 12 to the right against the biasing force of the spring members 27a, via the cam surfaces 26 and the yoke 22, causing the pinion 12 to disengage from the engagement portion 5a formed at the end of the spool shaft 5, thereby switching to the clutch OFF state P2. This state P2 is maintained by the toggle spring 23.

In addition, the clutch plate 25 is provided with the automatic return mechanism 30, which switches the clutch from the clutch OFF state P2 (see FIG. 3) to the clutch ON state P1 (see FIG. 2). As shown in FIG. 2, the automatic return mechanism 30 includes a kick member 31 connected to the clutch plate 25 so as to be swingable, and a ratchet 32 that is fixed to the handle shaft 8a so as not to rotate relative thereto. The kick member 31 is configured such that, when the clutch is switched from the clutch ON state P1 to the clutch OFF state P2, the distal end portion of the kick member 31 moves inside the rotational trajectory of the ratchet 32, as shown in FIG. 3. Therefore, when the handle 8 is operated to wind up in the clutch OFF state P2, the kick member 31 is hit (kicked) by the ratchet 32 and moves upward. With this movement, the clutch plate 25 rotates automatically in the clockwise direction, and the clutch is r from the clutch OFF state P2 to the clutch ON state P1. The clutch ON state P1 is maintained by the spring force of the toggle spring 23. Note that the clutch can also be returned by pushing up the clutch operating unit 21.

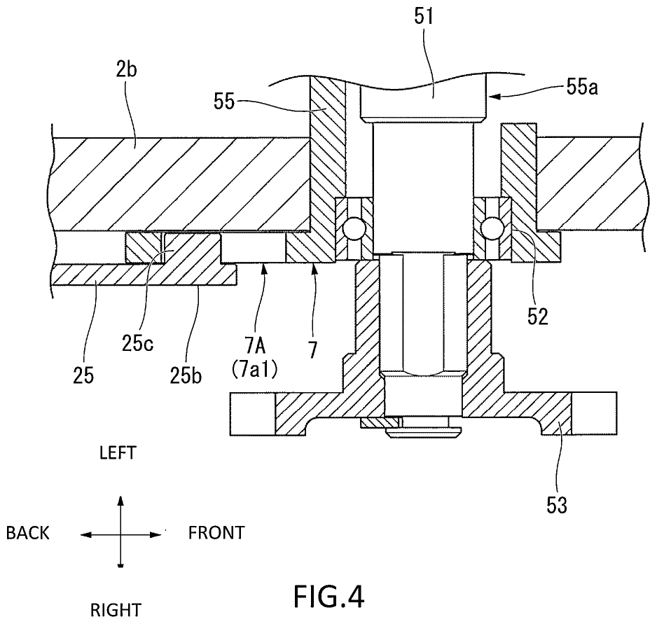

The level winding device 50 is disposed between the left and right side plates 1A, 1B in front of the spool 5A. The configuration of the level winding device 50 will be described below, with reference to FIGS. 4-8.

The level winding device 50 includes the line guide 60 through which the fishing line S, wound around the spool 5A, is inserted. This line guide 60 is configured to be moved left and right in a reciprocating fashion by a worm shaft 51 that is rotatably supported between the left and right side plates 1A, 1B via a shaft bearing 52, as shown in FIG. 4. The worm shaft 51 is a drive shaft that is rotatably driven via the drive force transmission mechanism 10. An input gear 53 is provided on the right frame 2b side of the worm shaft 51, adjacent to the drive gear 11, as shown in FIG. 1. The input gear 53 meshes with a connecting gear 8c that integrally rotates with the handle shaft 8a, as shown in FIG. 2. The worm shaft 51 is configured to be rotationally driven in synchronization with the rotational drive of the handle 8, via the connecting gear 8c and the input gear 53.

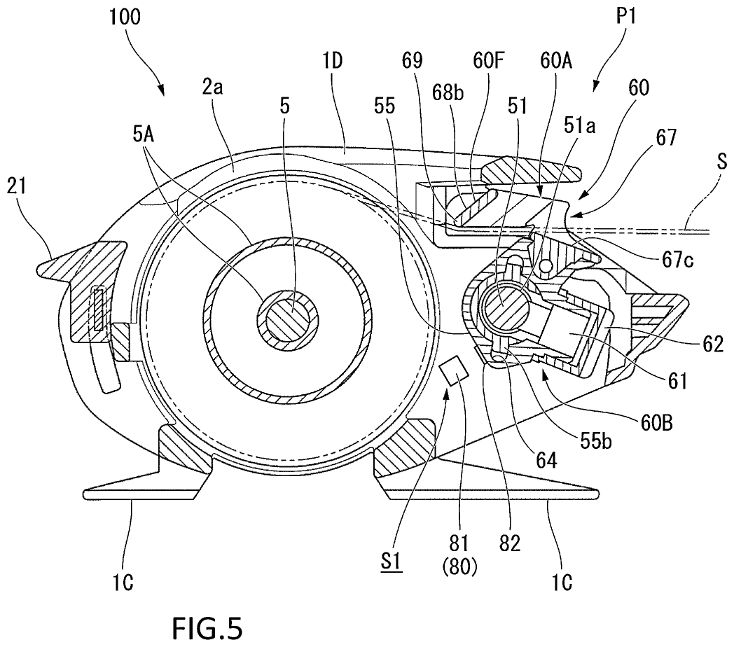

As shown in FIGS. 1 and 4, the worm shaft 51 is housed inside a cylindrical body 55 that is rotatably held between the left and right side plates 1A, 1B. A long hole 55a (see FIGS. 5, 7, and 8) that extends in the axial direction is formed on the outer surface of the cylindrical body 55. The long hole 55a partially exposes, along the axial direction, a spiral groove 51a formed on the surface of the worm shaft 51.

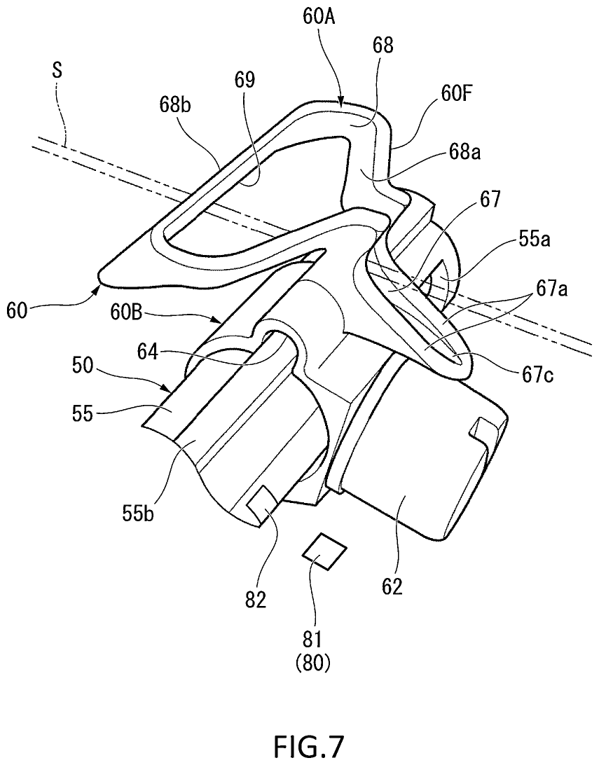

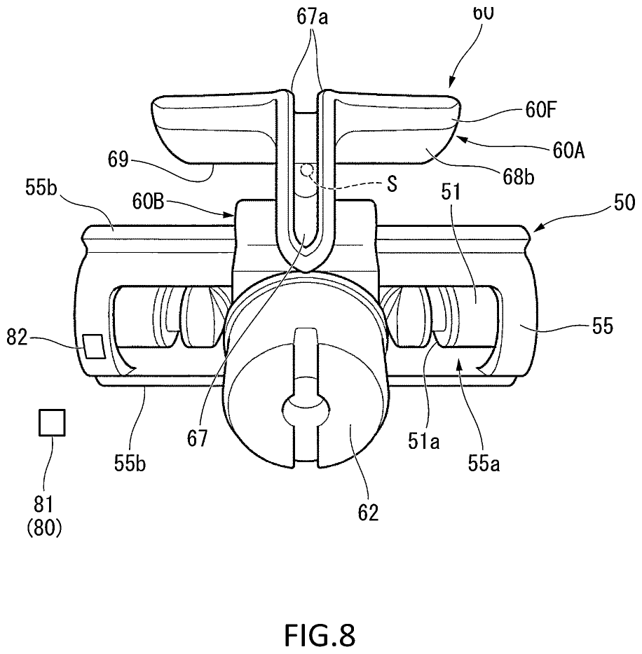

As shown in FIGS. 5 and 7, the line guide 60 integrally includes a guide part 60A (e.g., a shift mechanism) and a holding part 60B. The holding part 60B surrounds the cylindrical body 55, and as shown in FIG. 5, the holding part 60B holds a slider 61 therein. The slider 61 is engaged with the spiral groove 51a via the long hole 55a, and is fixed to the holding part 60B by a cap nut 62. In addition, the line guide 60 moves in the axial direction as the worm shaft 51 rotates due to the engagement relationship between the spiral groove 51a and the slider 61, but is prevented from rotating around the cylindrical body 55. In the present embodiment, rotation stopping elements 55b extend along the axial direction on the outer periphery of the cylindrical body 55, and engagement portions 64 of the holding part 60B engage with the rotation stopping elements 55b. Thus, the line guide is mounted so as to be prevented from rotation by the rotation stopping elements 55b. Specifically, in one embodiment, the rotation stopping elements 55b are protrusions that extend in the axial direction, and the engagement portions 64 are concave portions (see FIG. 5) that engage the protrusions 55b. As shown in FIGS. 5 and 8, the rotation stopping elements 55b can be a pair of rotation stopping elements 55b disposed at 180 degree intervals.

In addition, the line guide 60 is configured to be moved left and right in a reciprocating fashion between the left and right side plates 1A, 1B via the slider 61, when the worm shaft 51 is rotationally driven. The line guide 60 can be switched between the line winding state and the line releasing state in conjunction with the clutch ON/OFF of the clutch mechanism 20. In this case, the rotating of the line guide 60 is configured to be carried out by rotating the cylindrical body 55.

A power transmission path extending from the clutch mechanism 20 to the cylindrical body 55 will be specifically described next. As shown in FIG. 2, a protruding piece 25b that protrudes toward the front side of the reel body 1 is formed on the clutch plate 25. An engagement projection 25c that protrudes toward the right frame 2b side (left side) is integrally formed at the distal end of the protruding piece 25b. On the other hand, a rotating plate 7 is held by the right frame 2b at the portion where the worm shaft 51 is supported. As shown in FIG. 4, the rotating plate 7 is fixed to the cylindrical body 55 so as not to rotate relative thereto, on the inner surface side of the right frame 2b. A convex portion (not shown) that protrudes radially outward can be formed on the rotating plate 7, and a concave portion (not shown) formed at the end on the inner periphery of the cylindrical body 55 engages with the convex portion. As a result, the two elements are fixed in an integrally rotatable state on the inner peripheral side of the right frame 2b. The rotating plate 7 and the cylindrical body 55 can be integrally molded.

As shown in FIG. 4, the rotating plate 7 is rotatably supported between the right frame 2b and an outer race of the shaft bearing 52, which rotatably supports the worm shaft 51, extends rearward along the outer surface side of the right frame 2b, and overlaps with the protruding piece 25b of the clutch plate 25 in the left-right direction. As shown in FIG. 2, an upper engagement hole 7A and lower engagement hole 7B that are essentially L-shaped when viewed from the side are formed on the rotating plate 7. The upper engagement hole 7A is configured to transmit power from the clutch mechanism 20, and the lower engagement hole 7B is configured to transmit power from a switching unit 70A, constituting a part of the switching mechanism 70.

As shown in FIG. 2, the upper engagement hole 7A includes an upper first long hole 7al, and an upper second long hole 7a2 that is continuous with the upper first long hole 7al. The upper first long hole 7al is formed in a linear elongated hole shape that extends in the radial direction of the worm shaft 51. The upper second long hole 7a2 is formed in an arcuate long hole shape concentric to the worm shaft 51.

The engagement projection 25c of the clutch plate 25 is loosely inserted in the upper engagement hole 7A. As a result, as shown in FIGS. 2 and 3, the rotating plate 7 is configured to rotate about the axial center of the worm shaft 51 as the clutch plate 25 is rotated. Accordingly, the rotating plate 7 is configured to be switched between two positions, together with the clutch plate 25 that is toggled and held between the line winding state and the line releasing state by the toggle spring 23.

On the other hand, the lower engagement hole 7B has a lower first long hole 7b1, and a lower second long hole 7b2 that is continuous with the lower first long hole 7b1. The lower first long hole 7b1 is formed in a linear elongated hole shape that extends at a prescribed angle with respect to the radial direction of the worm shaft 51, and the lower second long hole 7b2 is formed in an arcuate long hole shape concentric to the worm shaft 51.

A protruding portion 721 is loosely inserted in the lower engagement hole 7B, and is provided on a friction device 72 of the switching mechanism 70. The rotating plate 7 is configured to rotate when the friction device 72 rotates due to the loose insertion of this protruding portion 721. That is, in addition to the rotating due to an operation of the clutch plate 25 described above, the rotating plate 7 is configured to also rotate with the operation of the switching mechanism 70.

A return spring 7c is attached between the right frame 2b and the front side portion of the rotating plate 7. The return spring 7c biases the rotating plate 7 in the counterclockwise direction and maintains the rotating plate 7 in the line winding state. The return spring 7c constitutes a part of the switching mechanism 70.

By the return spring 7c, the engagement projection 25c of the clutch plate 25 is configured to be held at a rear-end portion (e.g., the upper end portion of the upper second long hole 7a2) of the upper first long hole 7al of the upper engagement hole 7A, when in the line winding state (clutch ON state P1), as shown in FIG. 2. In addition, the protruding portion 721 of the switching mechanism 70 is held at a rear-end portion (e.g., the rear-end portion of the lower second long hole 7b2) of the lower first long hole 7b1 of the lower engagement hole 7B.

On the other hand, in the line releasing state (clutch OFF state P2) shown in FIG. 3, the engagement projection 25c of the clutch plate 25 is configured to be held at the front-end portion of the upper first long hole 7al. In addition, the protruding portion 721 of the switching mechanism 70 is configured to be held at the front-end portion of the lower second long hole 7b2.

As a result of the cylindrical body 55 being rotated via the rotating plate 7, the line guide 60 is rotated in the front-rear direction in front of the spool 5A.

Here, the configuration of the guide part 60A of the line guide 60 will be specifically described with reference to FIGS. 5-9. The guide part 60A is a portion for inserting the fishing line S from the spool 5A therethrough. The guide part 60A can be configured as a frame body 60F made of a material with low fishing line resistance, such as SUS or titanium, and is integrally formed with the holding part 60B. Specifically, a narrow (first) guide portion 67 that is narrow (i.e., has a thin groove shape) in the left-right direction, and a wide (second) guide portion 68 that expands in the left-right direction so as to be essentially symmetrical above the narrow guide portion 67, are provided. As shown in FIG. 8, the wide guide portion 68 is formed to have an essentially elliptical shape that expands in the left-right direction when viewed from the front. That is, when viewed from a front view as seen from the front along the fishing line S that is inserted. The two side walls of the wide guide portion 68 form inclined guide surfaces 68a that are inclined toward the narrow guide portion 67, formed in the lower part of the essentially center of the wide guide portion 68, to guide the fishing line S.

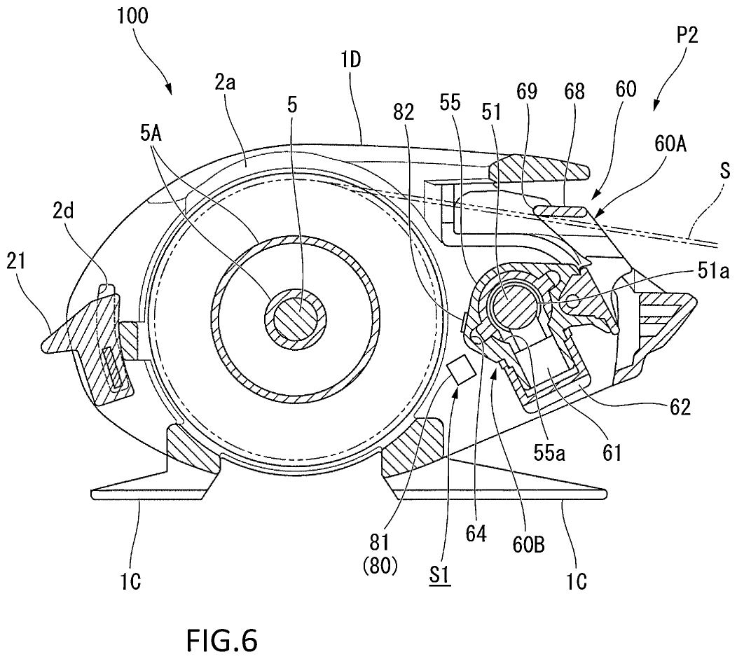

As shown in FIG. 5, the frame body 60F which includes the wide guide portion 68 is tilted with respect to the front-rear direction so as to gradually tile up toward the rear side, when viewed from the side in the line winding state (clutch ON state P1). As shown in FIG. 6, an upper wall 68b that defines the wide guide portion 68 is aligned along the front-rear direction in the line releasing state (clutch OFF state P2), and is configured to ensure the widest possible opening. Accordingly, the rear edge of the upper wall 68b is at a position capable of abutting, from above, the fishing line S inserted in the wide guide portion 68, when changed from the line releasing state to the line winding state, thus functioning as a regulating portion 69 that regulates the fishing line S.

The narrow guide portion 67 extends in the up-down direction and prevents left-right-direction wobble of the fishing line S that has entered therein, thereby achieving stable parallel winding of the fishing line onto the spool 5A, as shown in FIG. 1.

The switching mechanism 70 will be described next. As shown in FIG. 1, when the fishing line S is cast out against the drag force imparted by the drag device 8b, the switching mechanism 70 is rotatably driven so as to change the position of the line guide 60. As shown in FIGS. 2 and 3, the switching mechanism 70 comprises the switching unit 70A, the lower engagement hole 7B, and the return spring 7c. The switching mechanism 70 is disposed in the space between the handle shaft 8a and the worm shaft 51 of the level winding device 50. The switching unit 70A includes a one-way device 71 and the friction device 72. The one-way device 71 and the friction device 72 are arranged in a connected state inside the right side plate 1B. In the present embodiment, the one-way device 71 and the friction device 72 are arranged concentric to the handle shaft 8a.

In the present embodiment, the internal space of the reel body 1 includes a detection unit 80 that is provided in front of the spool shaft 5 and that detects the mode of the guide part 60A, as shown in FIGS. 5, 6, and 7. Specifically, the detection unit 80 has a magnetic sensor 81 that detects, via magnetism, a magnet 82 that is attached on a rearward-facing outer surface of the cylindrical body 55 of the holding part 60B, which is integrally provided with the guide part 60A. That is, the magnetic sensor 81 detects the mode (e.g., the swing position) of the cylindrical body 55, which shifts together with the guide part 60A. The magnetic sensor 81 can detect the rotational position of the cylindrical body 55, which rotates around the worm shaft 51, in accordance with the swing position of the guide part 60A.

As shown in FIG. 5, the magnetic sensor 81 is disposed in a space S1 inside the reel body 1 in front of the spool shaft 5, at a position opposing the magnet 82 of the cylindrical body 55 when in the clutch ON state P1. As shown in FIG. 6, the magnet 82 shifts together with the clockwise rotation X2 (see FIG. 2) of the cylindrical body 55 when in the clutch OFF state P2. At this time, since the magnet 82 moves away from the position opposing the magnetic sensor 81, the magnetism of the magnet 82 is not detected by the magnetic sensor 81. In this manner, it is possible to detect the clutch ON state P1 and the clutch OFF state P2 by the magnetic sensor 81 being rotated ON/OFF.

The action of the fishing reel 100 configured in this manner will be described in detail next, based on the drawings.

As shown in FIGS. 2 and 3, the fishing reel 100 of the present embodiment comprises the spool 5A that can cast the fishing line S forward in the first direction, the spool shaft 5 that is supported by the reel body 1 so as to be freely rotatable and that rotates integrally with the spool 5A, the clutch mechanism 20 that can switch between the transmitting state in which winding power is transmitted to the spool 5A and the dis-transmitting state in which transmission of the winding power to the spool 5A is cut off, and the clutch operating unit 21 for operating the clutch mechanism 20, provided rearward in the second direction that is opposite of the first direction with respect to the spool shaft 5. The fishing reel 100 includes a shift mechanism (e.g., line guide 60) that is in a first mode (clutch ON state P1) when the clutch mechanism 20 is in the transmitting state, and that can shift to a second mode (clutch OFF state P2) that is different from the first mode when the clutch mechanism 20 is in the dis-transmitting state, and the detection unit 80 that is provided in front of the spool shaft 5 and detects the mode of the shift mechanism.

By the fishing reel 100 according to the present embodiment, the detection unit 80 can detect changes in the position of the shift mechanism, such as the line guide 60 or a link mechanism that is moved by a clutch operation. The detection unit 80 is located in a first direction side that is different from the clutch operating unit 21 which is provided on the second direction or opposite side of the fishing line release direction of the spool shaft 5. That is, it is possible to detect, with the detection unit 80, the ON/OFF of a clutch based on the mode (first mode and the second mode) of the shift mechanism that shifts by operation of the clutch operating unit 21. In this manner, with the present embodiment, a space for embedding the detection unit 80 near the rear end of the reel body 1 near the end in the second direction is not necessary. As a result, the area at the clutch operating unit 21, the rear end of the reel body 1 does not protrude rearward in the second direction, thereby improving the palming performance of the fishing reel 100. In this manner, by the present embodiment, it is also not necessary to embed the detection unit 80 near the rear end of the reel body 1 near the end in the second direction. As a result, since a load is not applied to the rear side at the second direction side in the vicinity of the clutch operating unit 21 at the rear end of the reel body 1, the front-rear balance of the fishing reel 100 is not thrown off, thereby improving the casting performance.

In addition, in the present embodiment, the shift mechanism includes the line guide 60, which assumes the winding position for guiding the fishing line S to the spool 5A when in the first mode and assumes the releasing position for releasing the fishing line from the spool 5A when in the second mode. The detection unit 80 detects the position of the line guide 60, as the detected mode of the shift mechanism.

Therefore, as a result of the shift mechanism being equipped with the line guide 60 that can switch between the winding position and the releasing position, moving in accordance with the state of the clutch mechanism 20, the position of the line guide 60 can be detected with the detection unit 80. In this case, since the movement of position of the line guide 60 is relatively large, the detection of the ON/OFF positions of the clutch can be more reliably and accurately detected. In addition, since the clutch operating unit 21 and the line guide 60 are located basically on opposite sides across the spool shaft 5 in the front-rear direction, the rear end of the reel body 1 does not protrude rearward in the second direction, thereby improving the palming performance of the fishing reel 100.

Additionally, in the present embodiment, the line guide 60 includes the worm shaft 51 having the spiral groove 51a on the outer periphery, the cylindrical body 55 that is provided on the outer periphery of the worm shaft 51, that is opened along the axial direction of the worm shaft 51, and that has the long hole 55a that exposes a part of the spiral groove 51a, the slider 61 that engages with the spiral groove 51a via the long hole 55a and slides along the long hole 55a as the worm shaft 51 rotates, and the guide part 60A that guides the fishing line S. The guide part 60A has the narrow guide portion 67 that slides together with the slider 61 and has a narrow width in the axial direction of the spool shaft 5, and the wide guide portion 68 that has a wide width in the axial direction of the spool shaft 5. The guide part 60A is positioned at a swing position on the rear side about the worm shaft 51 so as to guide the fishing line S to the narrow guide portion 67 when in the winding position and is positioned at a swing position on the front side about the worm shaft 51 so as to guide the fishing line S to the wide guide portion 68 when in the releasing position. The detection unit 80 detects the swing position of the guide part 60A as the detected position of the line guide 60.

As a result of the shift mechanism having the line guide 60 that includes the worm shaft 51, the cylindrical body 55, the slider 61, and the guide part 60A, in which the guide part 60A has the narrow guide portion 67 and the wide guide portion 68 that can switch between the winding position and the releasing position, moving in accordance with the state of the clutch mechanism 20, the position of the line guide 60 can be detected with the detection unit 80. In this case, since the movement of the position of the guide part 60A of the line guide 60 is relatively large, the detection of the ON/OFF positions of the clutch can be more reliably and accurately detected. In addition, since the clutch operating unit 21 and the line guide 60 are located nearly on opposite sides across the spool shaft 5 in the front-rear direction, the rear end of the reel body 1 does not protrude rearward in the second direction, thereby improving the palming performance of the fishing reel 100.

Additionally, in the present embodiment, the detection unit 80 can detect the rotational position of the cylindrical body 55, which rotates around the worm shaft 51, in accordance with the swing position of the guide part 60A, as the detection of the swing position of the guide part 60A. Therefore, it is possible to detect, with the detection unit 80, the rotational position of the cylindrical body 55 that is rotationally driven by an operation of the clutch operating unit 21, such as one composed of a drive shaft of a level winding device.

In addition, in the present embodiment, since the detection unit 80 is the magnetic sensor 81 that detects the mode of the shift mechanism by magnetism, it is possible to detect the position of the shift mechanism by the detection unit 80 with a simple structure, composed of the magnet 82 and the magnetic sensor 81. Since this is not a complex structure, the small magnet 82 and the magnetic sensor 81 can be disposed using the small space S1 in front of the spool shaft 5 on the first direction side so that the space inside the reel body 1 can be effectively used.

By the fishing reel 100 of the present embodiment configured as described above, it is possible to reduce the rearward protrusion of the rear end of the reel body 1, thereby improving the palming performance of the fishing reel 100 during use. Additionally, in the present embodiment, it is possible to achieve balance between the front and rear of the fishing reel 100, thereby improving the casting performance.

The above-described embodiment of the fishing reel according to the disclosure is presented as an example and is not intended to limit the scope of the disclosure. The embodiment can be implemented in a variety of other forms; furthermore, various omissions, substitutions and changes can be made without departing from the essence of the disclosure. Embodiments include those that can be easily conceived of by a person skilled in the art, those that are substantially the same, and those that are of equivalent scope.

For example, in the present embodiment, a configuration in which the position of the line guide 60 is detected as the detected mode of the shift mechanism of the detection unit 80 is illustrated as an example, but no limitation is imposed by such a configuration. For example, the shift mechanism to be detected by the detection unit 80 can be, in addition to the line guide 60, a component member of a link mechanism that drives the line guide 60 from the clutch mechanism 20.

Additionally, the position of the detection unit 80 is not limited to the space S1 between the spool 5A and the cylindrical body 55, as in the present embodiment, as long as it is arranged in at first direction side with respect to the spool shaft 5 at the front side in the present embodiment. For example, the detection unit can be disposed in a space in front of the cylindrical body 55.

In addition, the magnetic sensor 81 that detects the mode of the shift mechanism by magnetism is exemplified as the detection unit 80 of the present embodiment, but no limitation is imposed by the magnetic sensor 81. Instead of the magnetic sensor 81, it is possible to employ, for example, a metal sensor, or a sensor, etc., that detects the rotation of the shift mechanism.

In addition, configurations such as the sizes and shapes of the reel body 1, the spool 5A, the clutch mechanism 20, the line guide 60, and the like, can be changed as appropriate.

What is claimed is:

1. A fishing reel, comprising:
a spool configured to cast a fishing line in a first direction;
a spool shaft supported by a reel body so as to be rotatable and configured to rotate integrally with the spool;
a clutch mechanism configured to switch between a transmitting state in which winding power is transmitted to the spool and a dis-transmitting state in which winding power is not transmitted to the spool;
a clutch operating unit configured to operate the clutch mechanism, provided in a second direction that is opposite of the first direction with respect to the spool shaft;
a shift mechanism being in a first mode while the clutch mechanism is in the transmitting state, and configured to shift to a second mode that is different from the first mode while the clutch mechanism is in the dis-transmitting state; and
a detection unit provided in the first direction with respect to the spool shaft and configured to detect the mode of the shift mechanism.

2. The fishing reel according to claim 1, wherein the shift mechanism includes a line guide configured to assume a winding position to guide the fishing line to the spool while in the first mode, and configured to assume a releasing position to release the fishing line from the spool while in the second mode, and the detection unit is configured to detect the position of the line guide, as the detection of the mode of the shift mechanism.

3. The fishing reel according to claim 2, wherein
the line guide includes
a worm shaft having a spiral groove on an outer periphery,
a cylindrical body provided on the outer periphery of the worm shaft, the cylindrical body having an elongated hole which opens along an axial direction of the worm shaft, and exposes a part of the spiral groove,
a slider configured to engage the spiral groove via the hole and slide along the hole as the worm shaft rotates, and
a guide part configured to guide the fishing line,
wherein the guide part includes
a first guide portion configured to slide together with the slider and having a first width in the axial direction of the spool shaft, and
a second guide portion having a second width in the axial direction of the spool shaft, the second width being wider than the first width,
wherein the guide part is positioned at a first swing position on a side in the first direction about the worm shaft so as to guide the fishing line to the second guide portion when in the releasing position, and
wherein the guide part is positioned at a second swing position on a side in the second direction about the worm shaft so as to guide the fishing line to the first guide portion when in the winding position, and
wherein the detection unit configured to detect at least one of the first swing position or the second swing position of the guide part as the detection of the position of the line guide.

4. The fishing reel according to claim 3, wherein the detection unit is configured to detect a rotational position of the cylindrical body configured to rotate around the worm shaft in accordance with at least the first swing position and the second swing position of the guide part, as the detection of the swing position of the guide part.

5. The fishing reel according to claim 1, wherein the detection unit is a magnetic sensor configured to detect the first mode of the second mode of the shift mechanism by magnetism.
